(19) United States
(12) Patent Application Publication
(10) Pub. No.: US 2021/0365343 A1
(43) Pub. Date: Nov. 25, 2021

(54) Artificial Intelligence (AI)-Based Cloud Computing Safety Monitoring System

(71) Applicant: National Marine Environmental Forecasting Center, Beijing (CN)

(72) Inventors: Bo Lin, Beijing (CN); Teng Xu, Beijing (CN); Yanqiang Wang, Beijing (CN)

(73) Assignee: National Marine Environmental Forecasting Center, Beijing (CN)

(21) Appl. No.: 17/161,357

(22) Filed: Jan. 28, 2021

(30) Foreign Application Priority Data
May 21, 2020 (CN) 202010433351.7

(51) Int. Cl. G06F 11/32; G06F 11/07; G06N 20/00

(52) U.S. Cl. CPC G06F 11/327; G06N 20/00; G06F 11/0709

(57) ABSTRACT

Disclosed is an AI-based cloud computing safety monitoring system, including a big data acquisition end, a server, and a cloud computing module. The system further includes a communications module and an AI module, where an output end of the server is connected to an input end of the cloud computing module, and a data transmission interface of the cloud computing module is connected to a transmission interface of the communications module. The AI module can be used to improve accuracy of an information content analysis result of a target object. An AI analysis module can be disposed to improve accuracy of a data obtaining analysis result, to improve a recognition speed and recognition efficiency. A remote monitoring terminal and an alarm module are externally connected, to raise an alarm in a timely manner when an emergency is recognized, and notify a user, so that the user can quickly obtain information.

### CROSS-REFERENCE TO RELATED APPLICATIONS

This application claims priority to Chinese Patent Application having serial number 202010433351.7, filed on May 21, 2020. The entirety of which is incorporated by reference herein.

### BACKGROUND OF THE INVENTION

### Field of the Invention

The present disclosure relates to the technical field of safety monitoring, and in particular, to an AI-based cloud computing safety monitoring system.

### Description of the Related Art

Artificial Intelligence (AI) is a new technical science that studies and develops theories, methods, technologies and application systems for simulating, extending, and expanding human intelligence. AI is a branch of computer science that seeks to understand a nature of intelligence and produces a new intelligent machine that can respond in a manner similar to human intelligence. In this field, a robot, language recognition, image recognition, natural language processing, an expert system, and the like are studied. Since AI has come into existence, theories and technologies have become more mature and the application field continues to expand. It is conceivable that in the future technology products brought by AI are a “container” of a human command. AI can simulate an information process of human consciousness and ideas. AI is not human intelligence but can think like a person and may even exceed the human intelligence.

AI systems are now widely used. AI systems have an autonomous learning capability and can be applied in a plurality of production environments. Currently, there is a relatively single cloud data processing manner. Data can only be calculated, controlled and stored, but data security cannot be monitored and an alarm cannot be raised. Consequently, system analysis and security monitoring cannot be implemented in an AI mode according to a type of data required by a user.

### SUMMARY OF THE INVENTION

Embodiments of the present disclosure provide an AI-based cloud computing safety monitoring system that includes a big data acquisition end, a server, and a cloud computing module. The system can further include a communications module and an AI module, where an output end of the big data acquisition end can be connected to an input end of the server. An output end of the server can be connected to an input end of the cloud computing module, a data transmission interface of the cloud computing module can be connected to a transmission interface of the communications module, and the transmission interface of the communications module can be connected to a transmission interface of the AI module.

In certain embodiments, the AI module can include an input end, a processor, an output end, and an AI analysis module, an output interface of the input end can be connected to an input interface of the processor through a data cable, an output interface of the processor can be connected to the output end through a data cable, and a transmission interface of the processor can be connected to the AI analysis module through a data cable.

In certain embodiments, the big data acquisition end can acquire data information and output the data information to the server. The server can output the data information to the cloud computing module, and the cloud computing module can perform preliminary recognition processing on the data information.

In certain embodiments, the cloud computing module can output the data information to the AI module through the communications module, and the AI module can analyze the data information and obtain content of the data information.

In certain embodiments, the data information is input from the input end, and the processor and the AI analysis module analyze and process the data information and output an analysis and processing result to the cloud computing module through the communications module.

In certain embodiments, a storage module is disposed in the cloud computing module, the storage module stores basic data, analyzed and processed data information is compared with the basic data to obtain a comparison result, and an alarm is raised if the comparison result is incorrect, or no alarm is raised if the comparison result is correct.

In certain embodiments, the big data acquisition end, the server, the cloud computing module, the communications module, and the AI module are connected through wired transmission or wireless transmission.

In certain embodiments, the big data acquisition end, the server, the cloud computing module, the communications module, and the AI module are connected through wireless transmission.

In certain embodiments, one or several of a Wi-Fi transmission protocol, a Bluetooth transmission protocol, a GPRS transmission protocol, or a ZigBee transmission protocol are used for wireless transmission.

In certain embodiments, the AI-based cloud computing safety monitoring system further includes an alarm module, and the alarm module is connected to the output end of artificial intelligence module through a data cable.

In certain embodiments, the AI-based cloud computing safety monitoring system further includes a remote monitoring terminal, and a data transmission connection is established between the remote monitoring terminal and the communications module.

In certain embodiments, the alarm module is a light alarm or a loudspeaker alarm.

The AI module can be used to improve accuracy of a data information content analysis result. The AI analysis module can be used to improve accuracy of a data analysis result to improve a recognition speed and recognition efficiency. A remote monitoring terminal and an alarm module can be externally connected to raise an alarm in a timely manner when an emergency is recognized and notify a user so that the user can quickly react and/or obtain information.

### BRIEF DESCRIPTION OF THE DRAWINGS

FIG. 1 depicts a flow diagram of an illustrative AI-based cloud computing safety monitoring system, according to one or more embodiments provided herein.

FIG. 2 depicts a system logical block diagram of an AI module, according to one or more embodiments provided herein.

### DETAILED DESCRIPTION

The following clearly and completely describes the technical solutions in the embodiments of the present disclosure with reference to accompanying drawings in the embodiments of the present disclosure. Apparently, the described embodiments are merely some rather than all of the embodiments of the present disclosure. All other embodiments obtained by a person of ordinary skill in the art based on the embodiments of the present disclosure without creative efforts shall fall within the protection scope of the present disclosure.

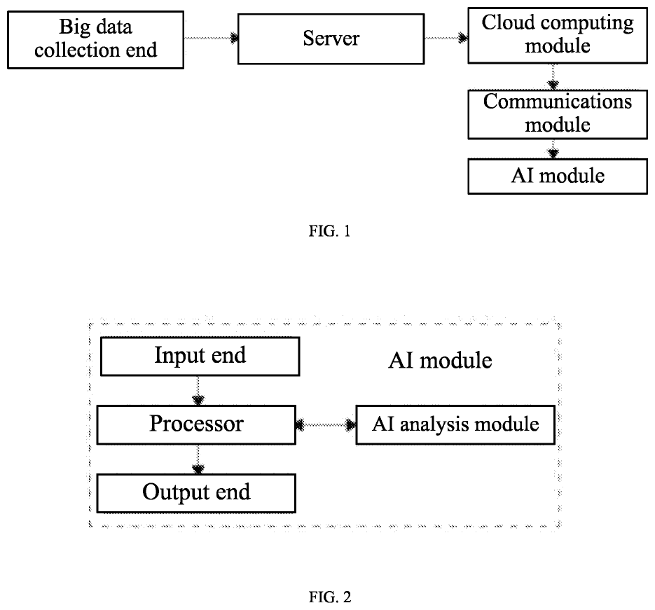

Referring to FIG. 1 and FIG. 2, the present disclosure provides In certain embodiments, the an AI-based cloud computing safety monitoring system, including a big data acquisition end, a server, and a cloud computing module. The system further includes a communications module and an AI module, an output end of the big data acquisition end can be connected to an input end of the server, an output end of the server can be connected to an input end of the cloud computing module, a data transmission interface of the cloud computing module can be connected to a transmission interface of the communications module, and the transmission interface of the communications module can be connected to a transmission interface of the AI module.

Specifically, the big data acquisition end can be limited to a video image data acquisition end or a single graphic data acquisition end. In this case, a Haikang fisheye camera whose model can be DS-2CD3955FWD-IWS can be used for the big data acquisition end. Actually, any IP camera that can support secondary development of SDK can be used. Compared with an ordinary camera, the fisheye camera can be distorted. Therefore, the fisheye camera usually needs to be anti-distorted in application, causing a relatively large delay. Therefore, the ordinary camera can be used if there can be no specific requirement.

The big data acquisition end acquires a video flow. The video flow refers to transmission of video data. For example, the video flow can be processed as a stable and continuous flow through a network. Because of the flow, a client browser or plug-in can display multimedia data before transmission of an entire file can be completed. A video flow technology develops based on a key technology, a video decoding technology, and scalable video distribution technology.

The AI module includes an input end, a processor, an output end, and an AI analysis module. An output interface of the input end can be connected to an input interface of the processor through a data cable, an output interface of the processor can be connected to the output end through a data cable, and a transmission interface of the processor can be connected to the AI analysis module through a data cable.

The big data acquisition end acquires image information of a target object and outputs the image information to the server. The server outputs the image information to the cloud computing module. The cloud computing module performs preliminary recognition processing on the image information.

The cloud computing module outputs the image information of the target object to the AI module through the communications module, and the AI module analyzes the image information of the target object and obtains content of the image information of the target object.

The image information of the target object can be input from the input end. The processor and the AI analysis module analyze and process the image information of the target object and output an analysis and processing result to the cloud computing module through the communications module. A storage module can be disposed in the cloud computing module, the storage module stores an original image, image information on which analysis processing can be performed can be compared with the original image to obtain a comparison result, and an alarm can be raised if the comparison result can be incorrect, or no alarm can be raised if the comparison result can be correct.

In a deep learning-based face recognition solution, face information in an image can be accurately recognized, to provide capabilities such as face attribute recognition, key point positioning, a 1:1 face comparison, 1:N face recognition, and living body detection.

The following aspects are mainly covered:

Living body detection: This provides a capability of detecting a face of a living body offline/online, to determine whether a user who performs an operation can be a real person in a face recognition process, effectively resist cheating attacks such as photos, videos, and molds, and ensure service security. The following functions are usually used in development of a mobile terminal.

Face detection: A face in the image can be detected, and a frame can be marked for the face. After a face can be detected, the face can be analyzed to obtain positioning of 72 key points such as an eye, a mouth, and a nose contour, to accurately recognize a plurality of face attributes such as a gender, an age, and an expression.

Face comparison: A face feature can be extracted, to calculate a similarity between two faces. In this way, whether there can be a same person can be determined, and a similarity score can be provided. This can be a comparison operation that helps confirm whether there can be the user when a user ID can be known, that can be, 1:1 identity authentication. The face comparison can be used for cases such as authentication of a real identity, and authentication of a one-to-one correspondence between a person and a certificate.

Face search: A photo can be given, and can be compared with N faces in a specified face database, to find one or a plurality of most similar faces. According to a matching degree between a to-be-recognized face and an existing face database, user information and the matching degree are returned, which can be 1:N face retrieval. The face search can be used for cases related to user identification and identity authentication.

Face collection from a video flow: Capabilities such as face detection, face tracking, and face collection are invoked offline, to quickly obtain a face image and ensure an obtained face. Image quality and an API interface are combined, to efficiently construct an application for recognizing faces in various scenarios.

The big data acquisition end, the server, the cloud computing module, the communications module, and the AI module are connected through wired transmission or wireless transmission. The big data acquisition end, the server, the cloud computing module, the communications module, and the AI module are connected through wireless transmission. One or several of a Wi-Fi transmission protocol, a Bluetooth transmission protocol, a GPRS transmission protocol, or a ZigBee transmission protocol are used for wireless transmission. The AI-based cloud computing safety monitoring system further includes an alarm module, and the alarm module can be connected to the output end of artificial intelligence module through a data cable. The AI-based cloud computing safety monitoring system further includes a remote monitoring terminal, and a data transmission connection can be established between the remote monitoring terminal and the communications module. The alarm module can be a light alarm or a loudspeaker alarm. Application: The user acquires indoor and outdoor video flows through the big data acquisition end, and enters face images to the cloud computing module and the AI module in advance. The face images are face images of family members, relatives, or friends, and are used to distinguish between unfamiliar face images. The cloud computing module and the AI module perform face recognition on the video flow acquired by the big data acquisition end. When a stranger in the video flow can be recognized, the alarm module starts an alarm, to attract attention of the user. When the stranger does not conform to the norm, the user can find the abnormality in a timely manner through the remote monitoring terminal, and perform processing such as an alarm in a timely manner. In addition, the video flow can be downloaded as a later reporting basis, to help the user use legal means to protect their own legitimate rights and interests.

Specifically, the system can also be applied to a marine forecasting service. For example, a real-time wave height of ocean waves can be acquired, and can be compared with an existing safe wave height, to determine whether to send a wave length alarm. Alternatively, an ocean current temperature and an ocean current speed are acquired, and are compared with a conventional safety value, to send a fishing operation alarm or a safety alarm to local fishermen.

The storage module disposed in this system records and stores information acquired each time, to prepare for future prediction and experience information.

In conclusion, in the AI-based cloud computing safety monitoring system in this application, the AI analysis module can be disposed to improve accuracy of a data obtaining analysis result, to improve a recognition speed and recognition efficiency. The remote monitoring terminal and the alarm module are externally connected, to raise an alarm in a timely manner when an emergency can be recognized, and notify the user, so that the user can quickly obtain information.

Although the embodiments of the present disclosure have been illustrated and described, it should be understood that a person of ordinary skill in the art may make various changes, modifications, replacements, and variations to the above examples without departing from the principle and spirit of the present disclosure, and the scope of the present disclosure is limited by the appended claims and equivalents thereof.

What is claimed is:

1. An artificial intelligence (AI)-based cloud computing safety monitoring system, comprising a big data acquisition end, a server, and a cloud computing module, wherein
the system further comprises a communications module and an AI module, an output end of the big data acquisition end is connected to an input end of the server, an output end of the server is connected to an input end of the cloud computing module, a data transmission interface of the cloud computing module is connected to a transmission interface of the communications module, and the transmission interface of the communications module is connected to a transmission interface of the AI module;
the AI module comprises an input end, a processor, an output end, and an AI analysis module, an output interface of the input end is connected to an input interface of the processor through a data cable, an output interface of the processor is connected to the output end through a data cable, and a transmission interface of the processor is connected to the AI analysis module through a data cable;
the big data acquisition end acquires data information and outputs the data information to the server, the server outputs the data information to the cloud computing module, and the cloud computing module performs preliminary recognition processing on the data information;
the cloud computing module outputs the data information to the AI module through the communications module, and the AI module analyzes the data information and obtains content of the data information;
the data information is input from the input end, and the processor and the AI analysis module analyze and process the data information and output an analysis and processing result to the cloud computing module through the communications module; and
a storage module is disposed in the cloud computing module, the storage module stores basic data, analyzed and processed data information is compared with the basic data to obtain a comparison result, and an alarm is raised if the comparison result is incorrect, or no alarm is raised if the comparison result is correct.

2. The AI-based cloud computing safety monitoring system according to claim 1, wherein the big data acquisition end, the server, the cloud computing module, the communications module, and the AI module are connected through wired transmission or wireless transmission.

3. The AI-based cloud computing safety monitoring system according to claim 2, wherein the big data acquisition end, the server, the cloud computing module, the communications module, and the AI module are connected through wireless transmission.

4. The AI-based cloud computing safety monitoring system according to claim 3, wherein one or several of a Wi-Fi transmission protocol, a Bluetooth transmission protocol, a GPRS transmission protocol, or a ZigBee transmission protocol are used for wireless transmission.

5. The AI-based cloud computing safety monitoring system according to claim 1, wherein the system further comprises an alarm module, and the alarm module is connected to the output end of artificial intelligence module through a data cable.

6. The AI-based cloud computing safety monitoring system according to claim 1, wherein the system further comprises a remote monitoring terminal, and a data transmission connection is established between the remote monitoring terminal and the communications module.

7. The AI-based cloud computing safety monitoring system according to claim 5, wherein the alarm module is a light alarm or a loudspeaker alarm.
